(19) United States
(12) Patent Application Publication
(10) Pub. No.: US 2008/0170508 A1
(43) Pub. Date: Jul. 17, 2008

(54) CHANNEL INTEGRITY METRIC CALCULATION

(75) Inventors: John J. Popiak, Schnecksville, PA (US); James P. Sagazio, Bethlehem, PA (US)

Correspondence Address: Driggs, Hogg, Daugherty & Del Zoppo Co., L.P.A., 38500 CHARDON ROAD, DEPT. ABB, WILLOUGHBY HILLS, OH, 44094, US

(73) Assignee: ABB TECHNOLOGY AG, Zurich (CH)

(21) Appl. No.: 11/623,984

(22) Filed: Jan. 17, 2007

(51) Int. Cl. G06F 11/00

(52) U.S. Cl. 370/252

(57) ABSTRACT

A first device (102), associated with an electrical substation, for example, automatically transmits a plurality of echo requests to a second device (104) that is in communication therewith by way of a communications channel (106). The second device (104) responds to the echo requests, and the first device (102) determines parameters relating to the echo requests, such as round trip times. The first device (102) calculates a channel quality metric as a function of the determined parameters.

### BACKGROUND

The present application relates to calculating and monitoring communications channel integrity. It finds particular application to communications channels used in connection with the transmission and distribution of electric power. The aspects disclosed below, however, can be employed with respect to any suitable communications channel where monitoring/calculating integrity of a communications channel is desired.

In some situations, it is especially important that a communications channel between two devices has sufficient quality to enable reliable communications between the devices. An example of one of such communications channels is a protection channel, such as a communications channel that enables two protective relays on either side of a feeder cable to communicate. More particularly, if a first protective relay detects a fault with respect to the feeder cable, the first protective relay may desirably transmit a command to the second protective relay that causes the feeder cable to be isolated. If the communications channel between the protective relays has insufficient quality or is otherwise down, a power transmission and distribution system may malfunction.

Conventionally, when two nodes desirably communicate with high reliability in a peer to peer application, a dedicated communications channel is employed. Examples of such a dedicated communications channel have included a dedicated analog or digital communications line. For example, signal to noise ratio (SNR) and bit to error ratio (BER) can be computed with respect to an analog and digital communications channel, respectively. This information has been used to ascertain the quality of the communications channel and hence ensure reliability of communications between two devices. While the use of dedicated communications channels (and the calculation of SNR or BER) has proven effective, such dedicated channels tend to be relatively expensive.

More recently, TCP/IP-based network protocols have become increasingly prevalent in electrical power transmission and distribution environment, industrial automation environment, and other environments. In many cases, desired intradevice communications can be implemented using common, off-the shelf (COTS) components such as routers, modems, hubs, switches, etc. Unfortunately, however, systems utilizing these components are not well-suited to the calculations of SNR, BER, or the like. Additionally, at least some of the protocols for utilization in the aforementioned environments, such as the Generic Object Oriented Substation Event (GOOSE) protocol, are unilateral in nature, such that a device that transmits a message does not receive an indication that the intended recipient, in fact, received the message. Such a situation can be problematic in cases where reliable intradevice communications is especially important.

### SUMMARY

Aspects of the present application address these matters, and others.

According to one aspect, an apparatus contains a memory that includes instructions for automatically transmitting a plurality of echo requests to a device that is in communication with the apparatus and computing a quality metric for a communications channel between the apparatus and the device based at least in part upon parameters of responses to the echo requests received from the device. The apparatus additionally includes a processor that is configured to execute the instructions within the memory.

According to another aspect, a method for ascertaining a quality of a communications channel between a first device and a second device includes transmitting an echo request from a first device to a second device and repeating the act of transmitting. The method further includes receiving one or more responses to the echo requests at the first device and computing channel quality as a function of parameters of the responses to the echo requests.

According to another aspect, a computer readable storage medium contains instructions which, when executed by a computer, cause the computer to carry out a method that includes automatically transmitting multiple echo requests over a communications channel to a device, receiving responses to a subset of the echo requests from the device, determining parameters of the received responses, and calculating a quality metric for the communications channel as a function of the determined parameters.

According to yet another aspect, an apparatus includes a requester that automatically transmits a plurality of echo requests to a device in communication with the apparatus by way of a communications channel, a response receiver that receives responses to the plurality of echo requests, and a channel quality calculator that computes a quality metric for the communications channel as a function of parameters of the received responses.

According to still another aspect, an apparatus contains a memory that includes instructions for receiving parameters relating to a plurality of responses to multiple echo requests, wherein the echo requests are transmitted from a first device to a second device and computing a channel quality metric for a communications channel over which the first device and the second device communicate, wherein the channel quality metric is computed as a function of the received parameters. The apparatus additionally includes a processor that is configured to execute the instructions within memory.

According to still another aspect, an apparatus includes means for automatically transmitting echo requests to a device in communication with the apparatus by way of a communications channel, means for determining parameters of responses to the transmitted echo requests, and means for calculating a quality metric for the channel based at least in part upon the determined parameters.

Those skilled in the art will appreciate still other aspects of the present application upon reading and understanding the attached figures and description.

### FIGURES

The present application is illustrated by way of example and not limitation in the figures of the accompanying drawings, in which like references indicate similar elements and in which:

FIG. 1 depicts a system that facilitates computing a channel quality metric.

FIG. 2 depicts a graph that illustrates different categories of channel quality.

FIG. 3 depicts a graph that illustrates channel quality index values.

FIG. 4 depicts a system that facilitates computing a channel quality metric.

FIG. 5 depicts a system that facilitates computing a channel quality metric.

FIG. 6 depicts a method for computing a channel quality metric.

FIG. 7 depicts a method for computing a channel quality metric.

FIG. 8 depicts an example utility system.

FIG. 9 depicts an example network architecture.

FIG. 10 depicts an example utility system.

### DESCRIPTION

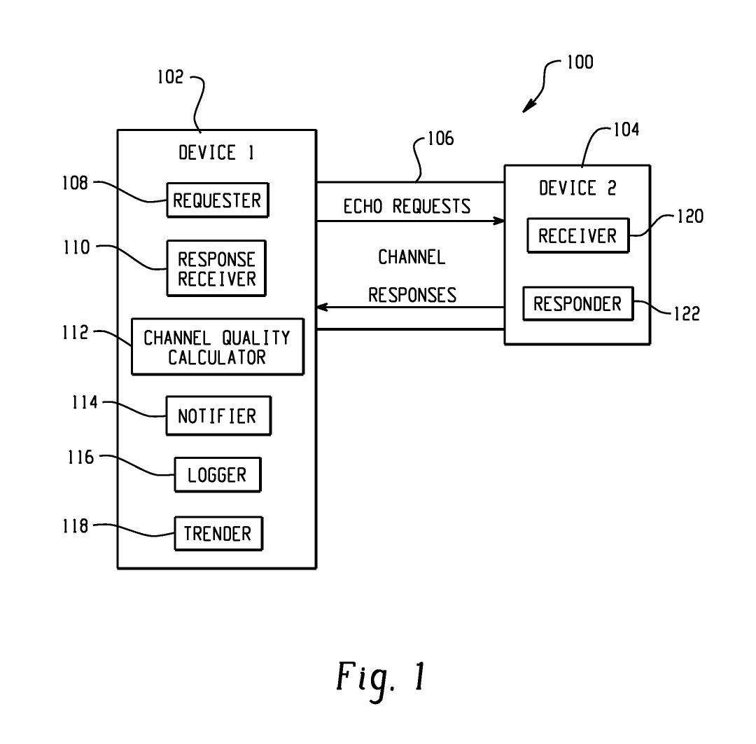

With reference to FIG. 1, a system 100 includes a first device 102 that is in communication with a second device 104 by way of a communications channel 106, wherein the first device 102 and the second device 104 can communicate through employment of a TCP/IP-based network protocol, such as Ethernet. The first device 102 includes a requester 108 that automatically creates a plurality of echo requests (e.g., pings) and transmits the echo requests to the second device 104 over the communications channel 106. A response receiver 110 within the first device 102 receives responses to the echo requests from the second device 104 and determines one or more parameters with respect to each received response.

A channel quality calculator 112 within the first device 102 utilizes the parameters of the echo requests determined by the response receiver 110 to compute a channel quality metric. The first device 102 can additionally include a notifier 114 that transmits a notification of channel quality as determined by the channel quality calculator 112 to an operator, an intelligent computer (which can automatically undertake action upon receipt of the notification), or both an operator and an intelligent computer. For instance, the notifier 114 can generate a notification and transmit the notification to an operator if the channel quality metric computed by the channel quality calculator 112 is below a threshold.

Additionally, the first device 102 may include a logger, wherein the logger 116 is configured to log channel quality metrics output by the channel quality calculator 112, echo response data output by the response receiver 110, notifications created by the notifier 114, or a combination thereof. The logged data is directed to a data repository (not shown) that may reside within the first device 102, the second device 104, another device, such as a server, or several distributed devices over a general geographic area.. The first device 102 can also include a trender 118, which can analyze data logged by the logger 116 to discern patterns and trends within the data. For instance, patterns and trends may be utilized for preventative maintenance purposes with respect to the communications channel 106. Additionally, the trender 118 can analyze logged data and predict when the communications channel 106 will have insufficient quality.

The second device 104 includes a receiver 120 that receives echo requests transmitted by the requester 108 by way of the communications channel 106. A responder 122 within the second device 104 responds to the echo requests received by the receiver 120. In more detail, the responder 122 transmits responses to the echo requests to the first device 102 by way of the communications channel 106. Parameters of the responses determined by the response receiver 110 are utilized by the channel quality calculator 112 to compute the quality metric.

The communications channel 106 by which the first device 102 and the second device 104 communicate can include but is not limited to copper cable, fiber-optic cable, airspace, Ethernet wiring, or other suitable media utilized to transfer data between the first device 102 and the second device 104 by way of a TCP/IP-based network protocol or other suitable network protocol. It is understood, however, that aspects described herein are not limited to any particular medium or media. Additionally, the communications channel 106 can, but need not, comprise one or more intermediary items that utilize common, off-the shelf technology, such as a router, a hub, a gateway, a switch, or other suitable device. Moreover, in a TCP/IP-based network protocol, two data packets transmitted from a first device to a second device at different points in time may travel along a different route. Additionally, other protocols can use aspects described herein in connection with determining channel quality. Examples of protocols used in the utility and industrial segment wherein aspects described herein can be used include but are not limited to various User Datagram Protocol (UDP) based protocols, such as GOOSE, Distributed Network Protocol (DNP) 3.0, or other protocols supported by IEC 61850 and/or the Utility Communications Architecture (UCA) group.

The echo requests transmitted by the requester 108 can be pings that are transmitted to the second device 104 by way of the communications channel 106. In more detail, the requester 108 can be configured to utilize the ping utility, which is often standard in devices configured for TCP/IP communications. The ping utility is a program that sends an Internet Control Message Protocol (ICMP) echo request message to a specified device and causes the specified device to respond with an ICMP echo response. Therefore, for instance, a transmitting device (e.g., the first device 102) can determine whether another device (e.g., the second device 104) is reachable, the “round trip” time of a data packet (a time between when an echo request is transmitted and when a response is received), a percentage of packet loss, or other parameters. Other echo request functions can also determine at least a subset of these parameters.

Additionally, the requester 108 can be programmed to generate a certain number of echo requests within a defined period of time. In another example, the requester 108 can create and transmit echo requests to the second device 104 from time to time. An amount of time between when the requester 108 creates and transmits echo requests can be a function of processor load, an amount of traffic on the communications channel 106, or any other suitable criteria. Additionally, the requester 108 can generate a plurality of echo requests that are provided to several different devices. Provision of echo requests to several devices may allow an individual to troubleshoot particular portions of a network by ascertaining which devices or mediums are a cause of poor channel quality.

The response receiver 110 ascertains parameters of responses to the echo requests from the second device 104. For instance, the response receiver 110 can ascertain an actual or approximated “round trip” time with respect to each echo request transmitted by the requester 108. In other words, the response receiver 110 determines a time between when the requester 108 transmitted the echo request and when the response receiver 110 received the response to the echo request from the responder 122. For example, response receiver 110 can include the ping utility in connection with determining the round trip time and other parameters. The response receiver 110 determines this round trip time for each echo request transmitted by the requester 108 to the second device 104 that has a corresponding response from the responder 122. Additionally, the response receiver 110 can determine an average round trip time with respect to a plurality of echo requests, can locate a minimum round trip time with respect to the plurality of echo requests, can locate a maximum round trip time with respect to the plurality of echo requests, a percentage of packet loss with respect to the echo request, and other suitable information that can be obtained from echo requests. Still further, the response receiver 110 determines instances that the requester 108 transmits an echo request to the second device 104 but no response is received.

As stated above, the channel quality calculator 112 computes a channel quality metric based at least in part upon parameters ascertained by the response receiver 110. Pursuant to an example, the channel quality calculator 112 receives an average round trip time with respect to a plurality of echo requests and calculates a channel quality metric based at least in part upon the average round trip time. In another example, the channel quality calculator 112 compares each round trip time determined by the response receiver 110 to a threshold time. If, for instance, a certain percentage of the round trip times is above the threshold time, then the channel quality calculator 112 can output a metric that indicates that the communications channel 106 has poor quality. In another example, if there is a certain percentage of packet loss with respect to a plurality of echo requests then the channel quality calculator 112 outputs a metric that indicates that the communications channel 106 has poor quality. In more detail, the requester 108 can transmit a plurality of requests, and the response receiver 110 may not receive a response that corresponds to each transmitted request. If a threshold number or percentage of transmitted requests do not have a corresponding response, then the channel quality calculator 112 can output a channel quality metric that indicates that quality of the communications channel 106 is average or poor. It is to be understood, however, that any suitable manner for interpreting or manipulating data determined by the response receiver 110 to calculate a channel quality metric is contemplated by the inventors and is intended to fall under the scope of the hereto-appended claims.

Moreover, the channel quality calculator 112 can utilize a rolling average technique in connection with calculating a quality metric with respect to the communications channel 106. With more specificity, the response receiver 110 can evaluate responses to echo requests from the responder 122 with respect to a moving time window of desired duration. In another example, the moving window may be established in relation to a desired number of ping requests, and does not consider information relating to echo requests that are not within the desired number of ping requests.

In a particular example, the channel quality calculator 112 can be programmed with the following algorithm or a similar algorithm in connection with calculating a quality metric based upon responses to echo requests:

```
SampleCounter = 0
PingAvg = (Ping-Stats[0] + Ping-Stats[1] + + Ping-
Stats[N−1] ) / N
PingAvg = (PingAvg + Latest-Ping-Stats − Ping-
Stats[SampleCounter]) / N
Ping-Stats[SampleCounter] = Latest-Ping-Stats
If SampleCounter < N
  SampleCounter = SampleCounter + 1
Else
  SampleCounter = 0
```

where N is a number of echo responses utilized to compute the rolling average and a resultant value for PingAvg correlates to a channel quality indicator. If N is a log₂(e.g., 2, 4, 8, 16, . . . ), then long division need not be undertaken, and could be replaced by a logical shift. For instance, if N is equal to 64, the channel quality calculator 112 can be programmed with the following algorithm:

```
SampleCounter = 0
PingAvg = (Ping-Stats[0] + Ping-Stats[1] + + Ping-
Stats[N−1] ) >> 6
PingAvg = (PingAvg + Latest-Ping-Stats − Ping-
Stats[SampleCounter]) ) >> 6
Ping-Stats[SampleCounter] = Latest-Ping-Stats
If SampleCounter < N
  SampleCounter = SampleCounter + 1
Else
  SampleCounter = 0
```

In yet another example, the channel quality calculator 112 considers information relating to all echo requests transmitted to the second device 104 by the requester 108 until a reset is automatically or manually selected.

In still yet another example, the channel quality indicator 112 can analyze the parameters and correlate current values of the parameters to one of several levels of quality, such as “good”, “medium”, and “poor.” It is understood and appreciated, however, that any suitable manner for determining an indication of channel quality based upon responses to echo requests are contemplated by the inventors and are intended to fall under the scope of the hereto-appended claims.

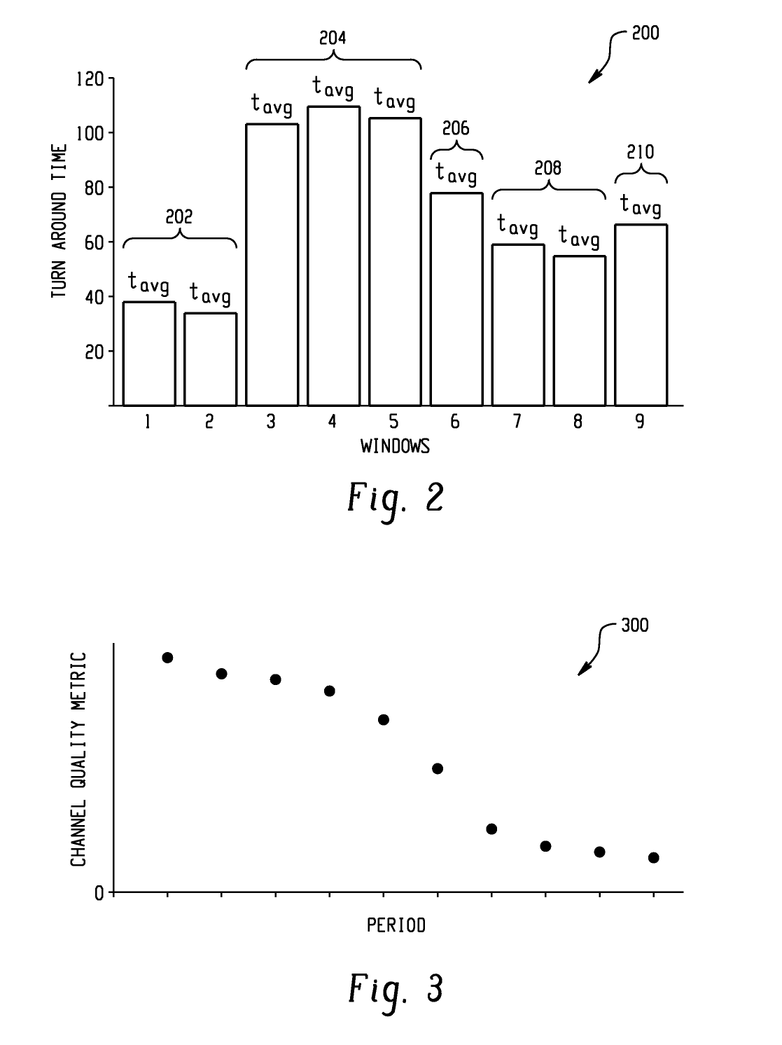

Turning briefly to FIG. 2, a graph 200 illustrating varying levels of channel quality with respect to several rolling averages over time is illustrated. During a first sliding window and second sliding window (shown as 202), channel quality is found to be “good.” For instance, an average round trip time with respect to a plurality of echo requests transmitted over a certain communications channel can be below a threshold time for channel quality that is “good.” In another example, a percentage of echo requests can have round trip times that are below a threshold (e.g., 80 percent of echo requests within a window of time can have round trip times below a threshold time). In this example graph 200, quality of a channel is categorized as “good” if an average response time is less than 60 milliseconds.

Moreover, additional quality information is generated and retained with respect to a minimum round trip time (tₘᵢₙ) and a maximum round trip time (tₘₐₓ) for responses to echo requests within a particular window of time. The measured quantities returned by the channel quality calculator 112 (FIG. 1) may be both a digital quantization (e.g., “good”, “medium”, “poor”, . . . ) and a measured performance of a channel, which may be determined as a function of minimum, maximum, and average response times over a particular window of time.

An additional three sliding windows 204 can have a channel quality that is “poor.” For example, an average round trip time with respect to echo requests transmitted within the sliding windows 204 can be above a threshold (e.g., above 100 milliseconds as shown). In another example, a percentage of echo requests can have round trip times that are below a threshold (e.g., 60 percent (or less) of echo requests within a window of time can have round trip times below a threshold). Still further, a particular percentage of packet loss can cause quality of a communications channel to be deemed “poor.”

A next sliding window 206 shows that channel quality is “medium” during such window 206, and thereafter channel quality is “good” for sliding windows 208. Similar to what is described above, a medium channel quality may be associated with an average round trip time that is above a threshold time for a channel quality that is “good” but below a threshold time for a channel quality that is “poor”(with respect to a plurality of echo requests within the sliding window). For instance, the channel quality may be deemed as “medium” if the average round trip time for echo requests in the window 210 is between 60 and 100 milliseconds. In another example, a percentage of echo requests can have round trip times that are below a threshold (e.g., 70 percent of echo requests within a window of time can have round trip times below a threshold time). Still further, a certain percentage of packet loss can cause quality of a communications channel to be deemed as being of “medium” quality. During another sliding window 210 channel quality is found to be “medium.”

Turning to FIG. 3, a graph 300 illustrates that an additional channel quality metric can be generated and reported. Such metric may be a dimensionless value that can be generated for each window of time or certain number of echo requests. This value may be a function of an average response time over a particular window of time or with respect to a certain number of echo requests, a maximum response time, a minimum response time, and/or a percentage of packet loss. The graph 300 illustrates ten different quality metrics generated with respect to different pluralities of echo response parameters.

Returning to FIG. 1, the notifier 114 transmits notifications to one or more operators, one or more computers, or a combination of at least one operator and at least one computer if the computed quality metric is below a particular value. If a metric is calculated that indicates that the communications channel 106 has insufficient quality, the notifier 114 provides information to an appropriate party indicating as much. The notification can be in the form of an e-mail, a text message, a voice message, an audible output, an alarm, or any other suitable notification. An operator or intelligent computer can then perform maintenance measures on the communications channel 106. In another example, the notifier 114 can, from time to time, transmit detected channel qualities to an operator, a computer, or both an operator or computer, regardless of whether the channel quality is insufficient.

With respect to the trender 118, such module 118 analyzes data logged by the logger 116 to determine patterns or trends resident within the logged data. To that end, the trender 118 can utilize machine learning techniques/algorithms, such as Bayesian Networks, Artificial Neural Networks, Support Vector Machines, etc. Additionally, the trender 118 can be employed to locate anomalies within logged data. Pursuant to an example, the trender 118 determines that a quality metric that is below a threshold is an anomaly and that it is not an indication that the communications channel 106 is unreliable or compromised. In more detail, the trender 118 waits until a consecutive number of quality metrics output by the channel quality calculator 112 are below a threshold before informing the notifier 114 to indicate to an operator that the communications channel 106 is unreliable and is in need of maintenance.

While not shown, it is understood that the first device 102 can be configured with the modules shown with respect to the second device 104 and that the second device 104 can be configured with the modules shown with respect to the first device 102. Thus, both devices can be configured to transmit echo requests, generate responses to received echo requests, ascertain parameters of echo requests, compute a quality metric with respect to a communications channel, etc.

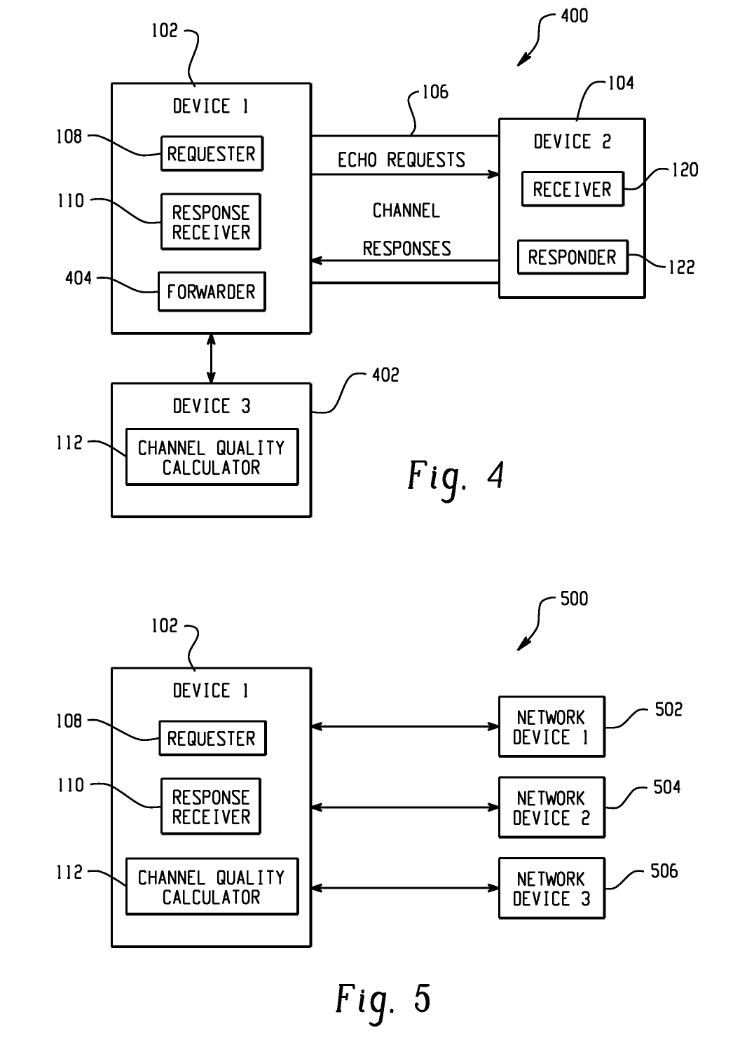

With reference now to FIG. 4, another example system includes the first device 102, the second device 104, and a third device 402, wherein the first device 102 and the second device 104 are in communication with one another by way of the communications channel 106 and the first device 102 and the third device 402 are communicatively coupled by any suitable communications medium. The first device 102 includes the requester 108 and the response receiver 110, and the second device 104 includes the receiver 120 and the responder 122. The requester 108, the response receiver 110, the receiver 120, and the responder 122 operate and interact as described above.

The first device 102 additionally includes a forwarder 404, which forwards information output from the response receiver 110 to the third device 402. The third device 402 includes the channel quality calculator 112, which computes a channel quality metric (as described above) based at least in part upon parameters ascertained by the response receiver 110 and forwarded thereto by the forwarder 404. The third device 402 can be any suitable computing device, such as a desktop computer, a personal digital assistant, a laptop computer, a mobile telephone, a hardwired contact data transfer mechanism, and the like.

Additionally, while not shown, the third device 402 can include the notifier 114, the logger 116, the trender 118 (FIG. 1), or any combination thereof. Furthermore, the first device 102 or the second device 104 may include the notifier 114, the logger 116, the trender 118, or any combination thereof, wherein the third device 402 transmits quality metrics computed by the channel quality calculator 112 to the first device 102. In yet another example, a fourth device (not shown) may include the notifier 114, the logger 116, the trender 118, or a combination thereof, such that channel qualities computed at the third device 402 by the channel quality calculator 112 are transmitted to the fourth device. Thus, a device that transmits echo requests and receives responses thereto need not compute channel quality; rather, as shown in the system 400, such computation can be performed by a different device.

Turning now to FIG. 5, an example system 500 is provided to illustrate that echo requests can be transmitted to a plurality of devices. The system 500 includes the first device 102, wherein the first device 102 is communicatively coupled to several other network devices 502, 504, and 506. The first device 102 includes the requester 108, the response receiver 110, and the channel quality calculator 1 12, which operate as described infra. The requester 108 can transmit a plurality of echo requests to each of the network devices 502, 504, and 506, and the response receiver 110 can receive responses from each of the network devices 502, 504, and 506 corresponding to the transmitted requests. To send an echo request to a particular party, the requester 108 can identity a Media Access Control (MAC) address or an Internet Protocol (IP) address of an intended recipient, and can individually transmit requests to each of the network devices 502, 504, and 506 based at least in part upon their MAC or IP addresses.

In another example, the requester 108 transmits echo requests to each device communicatively coupled thereto on a LAN. In other words, the requester 108 need not indicate a particular MAC address when transmitting the echo requests, but responding devices should indicate their identity when responding to echo requests. Therefore, the requester 108 broadcasts an echo request that is received by each of the network devices 502, 504, and 506. The response receiver 110 receives responses to the echo requests broadcast to the network devices 502, 504, and 506, and ascertains parameters such as average round trip time with respect to a plurality of echo requests for each of the network devices 502, 504, and 506. The channel quality calculator 112 receives such information from the response receiver 110 and generates a channel quality metric for each channel associated with the first device 102 based at least in part upon the received information.

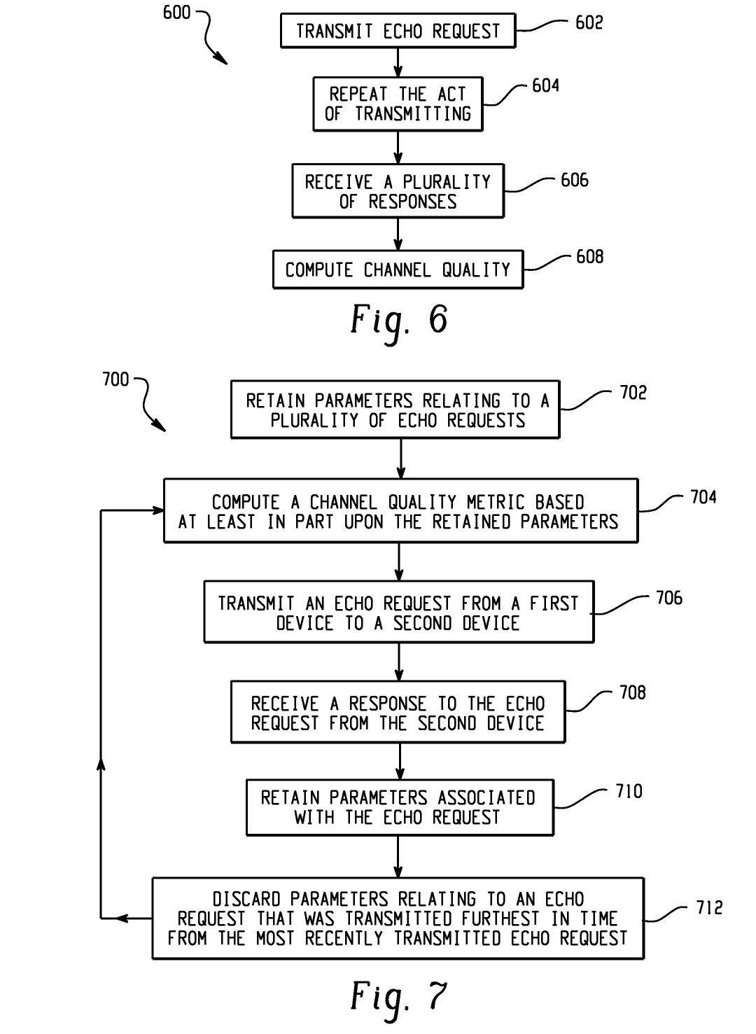

Referring now to FIGS. 6 and 7, methodologies for computing a channel quality metric with respect to a communications channel between two devices are illustrated. While for purposes of simplicity of explanation the methodologies are shown and described as a series of acts, it is understood and appreciated that the claimed subject matter is not to be limited by the order of execution of the acts, as some acts may occur in a different order or concurrently with other acts from that shown and described herein. Moreover, not all illustrated acts may be required to implement a methodology in accordance with the hereto-appended claims.

Referring solely to FIG. 6, a methodology 600 for determining a channel quality metric for a communications channel is illustrated. At 602, an echo request is transmitted from a first device to a second device, and at 604 the act of transmitting the echo request at the first device is repeated. At 606, one or more responses to the transmitted echo requests are received at the first device from the second device. At 608, a channel quality metric is computed as a function of parameters of the received responses.

With reference to FIG. 7, a methodology 700 for computing a quality metric for a communications channel between two devices by way of a rolling average approach is illustrated. At 702, parameters relating to a plurality of echo request responses are retained. At 704, a channel quality metric is computed based at least in part upon the retained parameters. At 706, an echo request is transmitted from a first device to a second device, and at 708 a response to the echo request is received from the second device at the first device. At 710, parameters of the transmitted echo request are retained. At 712, retained parameters relating to an echo request transmitted furthest in time from the most recently transmitted echo request are discarded. In other words, “oldest” parameters are discarded and replaced with “newest” parameters. Thereafter, the methodology 700 returns to act 704, where a channel quality metric is computed based at least in part upon the retained parameters.

With respect to the systems and methods described above, devices described in connection therewith can be intermediary devices commonly found within TCP/IP-based networks, including but not limited to a server, a modem, a router, a hub, a switch, a gateway, a radio transceiver, etc. Further, devices described herein can be end nodes that are common to TCP/IP-based networks, such as personal computers, laptop computers, personal digital assistants, mobile phones, and the like. In yet another example, the devices can be configured for TCP/IP-based communications as well as specialized functions, wherein such functions are useful in an industrial automation environment. Accordingly, for instance, one or more of the communications devices can be a programmable logic controller, a robotic controller, or other suitable controller.

Still further, the devices can be configured to perform functions in connection with power transmission and distribution. For instance, at least one of the devices can be a field device that is used in connection with a substation, such as a sensor, a relay, a circuit breaker, a regulator, a recloser, a disconnect switch, a circuit switcher, a transformer, a meter, and a voltage regulator. Additionally, one or more of the communications devices described herein can be Intelligent Electronic Devices (IEDs), which are microprocessor-based field devices configured for controlling power system equipment. Example IEDs include capacitor banks, protection relays, circuit breakers, and other intelligent electronic devices. Therefore, the channel quality calculator 114 can be employed in connection with ascertaining quality of a protection channel utilized in a power distribution and transmission system.

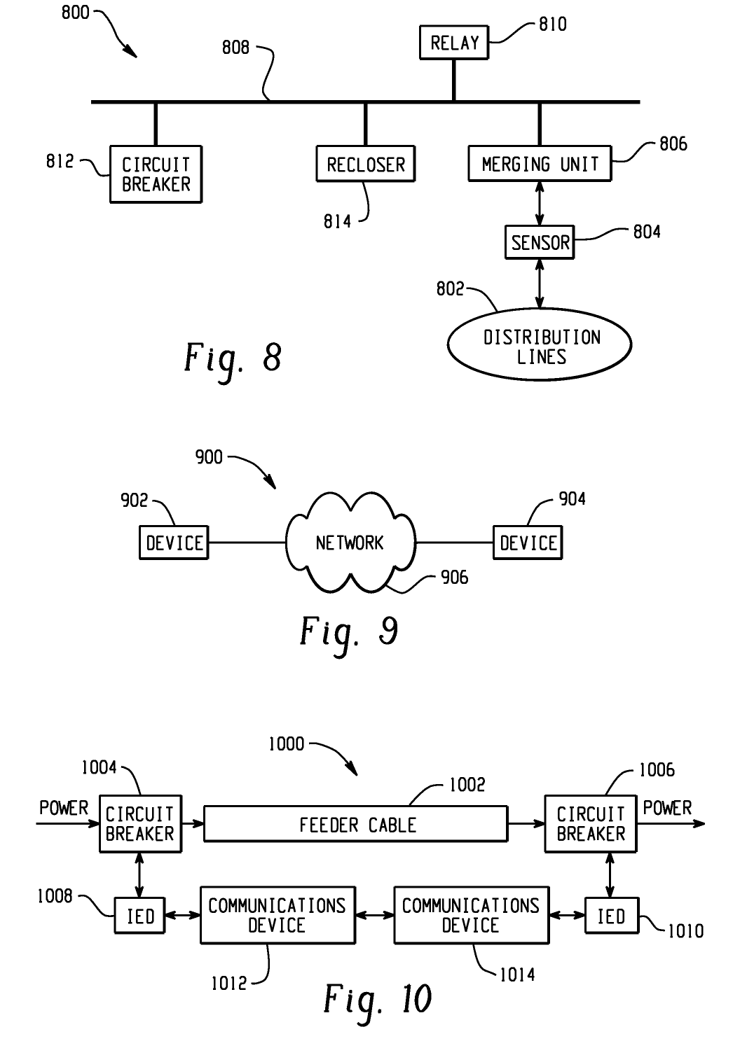

Now referring to FIG. 8, an example system 800 illustrates determining quality of a protection channel utilized in connection with a power transmission and distribution environment. The system 800 includes distribution lines 802 that distribute power to a plurality of consumers. A sensor 804 samples parameters (e.g., voltage, current, . . . ) of the distribution lines 802 and provides the samples to a merging unit 806. The merging unit 806 places the samples upon an Ethernet process bus 808, wherein such samples are monitored by, for instance, a relay 810, a circuit breaker 812, and a recloser 814. Similarly, the relay 810, the circuit breaker 812, and the recloser 814 can place data upon the process bus 808, and other devices resident upon the bus 808 can monitor the data and act in response to the data.

Accordingly, it can be discerned that it is important that the process bus 808 in general, and communications channels between the merging unit 806 and the relay 810, the relay 810 and the circuit breaker 812, and the circuit breaker 812 and the recloser 814 have high integrity and quality to ensure that important data sent by one device is received by the intended device.

Utilizing aspects described herein, the relay 810, for instance, transmits a plurality of echo requests (e.g., within a defined window of time) to the circuit breaker 812, and the circuit breaker 812 provides the relay 810 with responses to the request. Parameters relating to each of the echo requests are ascertained by the relay 810, and the relay 810 determines a channel quality based at least in part upon such parameters. Therefore, if a fault exists with respect to the distribution lines 802, the relay 810 can transmit a command to the circuit breaker 812 to trip such breaker 812 with confidence that the process bus 808 has sufficient channel quality, and the desired action is effectuated.

Now referring to FIG. 9, a more expansive implementation 900 of utilization of intermediate nodes in a network environment is illustrated. Devices 902 and 904 are interconnected by a network of interface devices and media 906 along a communications path, where the network of interface devices can include interface devices that are known and unknown. The interface devices and media 906 can include air, wirelined connections, switched connections, and the like, such that a path between the devices 902 and 904 is not known by an operator and is subject to variation. In a particular example, the devices 902 and 904 may be communications devices that are utilized to enable, for instance, the relay 810 and the recloser 814 (FIG. 8) to communicate with one another. Thus, the devices 902 and 904 and the network of interface devices and media 906 may reside between the relay 810 and the recloser 814 on the bus 808. Through use of aspects described herein, however, a channel quality metric and/or category can be determined.

With reference now to FIG. 10, another example system 1000 illustrates determining quality of a protection channel utilized in connection with a power transmission and distribution environment utilizing TCP/IP based communications instead of traditional schemes. The system 1000 includes a feeder cable 1002 receives power at one end thereof and outputs power at the other end thereof. Circuit breakers 1004 and 1006, respectively are placed at either end of the feeder cable 1002, such that the feeder cable 1002 can be isolated in the event of a fault. Each of the circuit breakers 1004 and 1006 are in communication with IEDs 1008 and 1010, respectively. The IEDs 1008 and 1010 can communicate with one another through utilization of common, off-the shelf communications devices 1012 and 1014, such as radio transceivers.

In the system 1000, the IEDs 1008 and 1010 can be protective relays. If, for instance, the circuit breaker 1004 is tripped, the IED 1008 transmits a message to the IED 1010 (by way of the communications devices 1012 and 1014) indicating to the IED 1010 that the circuit breaker 1006 should also be tripped. Accordingly, monitoring quality of the protection channel between the IED 1008 and the IED 1010 is very important. Accordingly, for example, the IED 1008 transmits echo requests to the IED 1010, and the IED 1008 further evaluates responses to the echo requests transmitted by the IED 1010. Based upon parameters of the responses, the IED 1010 can ascertain a quality metric for the protection channel.

While the above example systems illustrate protection channels, it is to be understood that aspects described herein can also be employed upon control channels.

Of course, modifications and alterations will occur to others upon reading and understanding the preceding description. It is intended that the invention be construed as including all such modifications and alterations insofar as they come within the scope of the appended claims or the equivalents thereof

What is claimed is:

1. An apparatus, comprising:
a memory that comprises instructions for:
automatically transmitting a plurality of echo requests to a device that is in communication with the apparatus; and
computing a quality metric for a communications channel between the apparatus and the device based at least in part upon parameters of responses to the echo requests received from the device; and
a processor that is configured to execute the instructions within the memory.

2. The apparatus of claim 1, wherein the echo requests are initiation through utilization of the ping utility.

3. The apparatus of claim 1, wherein the communications channel is within one or more of a local area network or wide area network that utilizes the Ethernet protocol.

4. The apparatus of claim 1 being an intelligent electronic device.

5. The apparatus of claim 1, wherein the parameters include round trip times of the echo requests.

6. The apparatus of claim 1, the memory comprises further instructions for computing the quality metric based at least in part upon parameters of responses to a subset of the echo requests that were transmitted within a defined window of time.

7. The apparatus of claim 1, the memory comprises further instructions for transmitting a notification to one or more of an operator and an intelligent computer if the quality metric is below, above, or between predefined threshold(s).

8. The apparatus of claim 1, the memory comprises further instructions for logging computed quality metrics.

9. The apparatus of claim 1, the memory comprises further instructions for transmitting messages that conform to protocols that are based upon the User Datagram Protocol.

10. The apparatus of claim 1, the memory comprises further instructions for:
transmitting an additional echo request to the device; and
recomputing the quality metric upon ascertaining parameters of a received response to the additional echo request.

11. The apparatus of claim 10, the memory comprises further instructions for disregarding parameters of a received response prior to recomputing the quality metric.

12. A computer-implemented method for ascertaining a quality of a communications channel between a first device and a second device comprising the following computer-executable acts:
transmitting an echo request from a first device to a second device;
repeating the act of transmitting;
at the first device, receiving one or more responses to the echo requests; and
computing channel quality as a function of parameters of the responses to the echo requests.

13. The method of claim 12, wherein the parameters include round trip time with respect to each echo request.

14. The method of claim 12, wherein the first device is a utility device configured for employment in connection with an electrical substation.

15. The method of claim 12, further comprising undertaking a rolling average approach when computing the channel quality metric.

16. The method of claim 12, further comprising transmitting a message that is compatible with peer to peer transmission.

17. The method of claim 12, further comprising configuring the first device to communicate in an Ethernet-based network.

18. The method of claim 12, further comprising:
logging a plurality of computed channel quality metrics over time;
analyzing the logged channel quality metrics to discern patterns; and
predicting when channel quality will reside outside threshold(s).

19. The method of claim 12, further comprising computing the quality metric as a function of parameters of a subset of responses received at the first device within a defined window of time.

20. A computer readable storage medium containing instructions which, when executed by a computer, cause the computer to carry out a method comprising:
automatically transmitting multiple echo requests over a communications channel to a device;
receiving responses to a subset of the echo requests from the device;
determining parameters of the received responses; and
calculating a quality metric for the communications channel as a function of the determined parameters.

21. The computer readable storage medium of claim 20, wherein determining the parameters comprises determining a number of responses that have a round trip time that is outside threshold time(s).

22. The computer readable storage medium of claim 20, wherein determining the parameters comprises determining an average round trip time for the received responses.

23. The computer readable storage medium of claim 20, wherein determining the parameters comprises determining an amount of packet loss with respect to the multiple echo requests.

24. The computer readable storage medium of claim 20, the method further comprising categorizing the channel quality into one of several predefined categories.

25. The computer readable storage medium of claim 20, wherein calculating the quality metric comprises utilizing a rolling average approach to calculate the quality metric.

26. An apparatus comprising:
a requester that automatically transmits a plurality of echo requests to a device in communication with the apparatus by way of a communications channel;
a response receiver that receives responses to the plurality of echo requests; and
a channel quality calculator that computes a quality metric for the communications channel as a function of parameters of the received responses.

27. The apparatus of claim 26 being a utility device suitable for deployment in connection with a substation.

28. An apparatus, comprising:
a memory that comprises instructions for:
receiving parameters relating to a plurality of responses to multiple echo requests, wherein the echo requests are transmitted from a first device to a second device; and
computing a channel quality metric for a communications channel over which the first device and the second device communicate, wherein the channel quality metric is computed as a function of the received parameters; and
a processor that is configured to execute the instructions within memory.

29. An apparatus comprising:
means for automatically transmitting echo requests to a device in communication with the apparatus by way of a communications channel;
means for determining parameters of responses to the transmitted echo requests; and
means for calculating a quality metric for the communications channel based at least in part upon the determined parameters.
